(19) United States
(12) Patent Application Publication
(10) Pub. No.: US 2018/0112525 A1
(43) Pub. Date: Apr. 26, 2018

(54) Method of Determination of Parameters of the Fracture Near Wellbore Zone Filled with Electrically Conductive Proppant Using Electromagnetic Logging

(71) Applicant: SCHLUMBERGER TECHNOLOGY CORPORATION, Sugar Land, TX (US)

(72) Inventors: Artem Valeryevich KABANNIK, Novosibirsk (RU); Sergey Alexandrovich KALININ, Novosibirsk (RU); Olga Petrovna ALEKSEENKO, Novosibirsk (RU); Dean M. HOMAN, Sugar Land, TX (US)

(21) Appl. No.: 15/562,949

(22) PCT Filed: Mar. 30, 2015
(86) PCT No.: PCT/RU2015/000197

§ 371 Date: Sep. 29, 2017

(51) Int. Cl. E21B 49/00; E21B 43/267; G01V 3/28

(52) U.S. Cl. CPC E21B 49/00; G01V 3/28; E21B 43/267

(57) ABSTRACT

The claimed technical decision relates to downhole systems for the production of various fluids—in particular, for the production of fluid from a hydrocarbon-bearing formation with the use of hydraulic fracturing. According to the claimed technical decision, a method is disclosed for determining the parameters of the hydraulic fracture near wellbore zone, wherein a cased well with a cemented casing and perforation clusters within the predefined hydraulic fracturing zone or an open hole well is provided. Then, electromagnetic logging is performed prior to formation hydraulic fracturing. The stage, during which the fracturing fluid not containing proppant is injected into the well, and the stage, during which the fracturing fluid containing electrically non-conductive proppant is injected into the well, are performed. Following this, the stage is performed, during which the fracturing fluid containing electrically conductive proppant is injected into the well. Thereafter, fracturing fluid flowback and fracture clean-up are performed; electromagnetic logging is performed within the predefined hydraulic fracturing zone to record measured responses from the near wellbore zone hydraulic fracture; and the parameters of the hydraulic fracture near wellbore zone are determined.

### BACKGROUND

The present disclosure relates to hydrocarbon production stimulation by means of formation hydraulic fracturing.

The known prior art solution disclosed in WO 2014004815 A1 describes the injection of fracturing fluid, proppant, and a probing additive into a well to form a hydraulic fracture. The known solution may also comprise the use of an electrically conductive casing in such a way that the probing additive would emit an electromagnetic field, the investigation of this electromagnetic field, and determination of the fracture location based on the investigated electromagnetic field.

The known prior art solution disclosed in U.S. Pat. No. 5,151,658 A represents a three-dimensional system for detecting fractures and their distribution in the Earth's crust, using an artificial magnetic field, which comprises: a tracer, composed of magnetic particles, embedded in fractures in the Earth's crust, having high magnetic permeability and specific gravity approximately equal to the specific gravity of liquid present in the fracture, as well as magnetic field detecting devices suspended inside wellbores drilled in the Earth's crust and comprising transmitters and receivers operating at a certain frequency.

The solution disclosed in US 20140184228, A1 proposes a method for treating the Earth's interior through a well, which comprises the injection of electrically conductive or electromagnetic fibres into the Earth's interior in the course of formation hydraulic fracturing. Suitable metal materials, organic polymers, and organic polymers covered with or containing electrically conductive or electromagnetic materials are described. The treatment is followed by measuring specific resistance and/or electromagnetic properties in particular, by conducting a crosshole electromagnetic survey.

The solution disclosed in US20100147512, A1 proposes a method for surveying fractures, which comprises: placement of electrically active (EA) proppant into a fracture, charging of this proppant via an electric signal, detection of the electric signal via one or more antennas and acquisition of a fracture image using a recorded signal, wherein the proppant comprises EA particles, EA fracturing fluid, or combinations thereof.

The solutions known from the prior art did not address the determination of fracture parameters in its near wellbore zone with the injection of electrically conductive proppant and the use of electromagnetic logging from single well.

The present disclosure is directed for creating a procedure for the determination of fracture parameters in its near wellbore zone with injection of electrically conductive proppant and the use of electromagnetic logging from single well.

### SUMMARY

The description discloses a new approach to the determination of the parameters of the hydraulic fracture near wellbore zone, such as the width, height, dip angle and azimuth of the fracture, and the length of the fracture near wellbore zone.

According to the claimed disclosure, a method is disclosed for determining the parameters of the hydraulic fracture near wellbore zone, wherein a cased well with a cemented casing and perforation clusters within the predefined hydraulic fracturing zone or an open hole well is provided. Then, electromagnetic logging is performed before formation hydraulic fracturing within the predefined zone of the pay formation to record response from the medium without a fracture, followed by theoretically predicting of both hydraulic fracture dimensions and the volumes of fluid and proppant required for injection. The first stage is performed, during which the fracturing fluid not containing proppant is injected into the well, using both the predicted hydraulic fracture dimensions and the volumes of fluid and proppant required for injection to create a fracture in the formation. Then, the next stage is performed, during which the fracturing fluid containing electrically non-conductive proppant is injected into the well, using both the predicted hydraulic fracture dimensions and the volumes of fluid and proppant indispensable for injection. Following this, the last stage is performed, during which the fracturing fluid containing electrically conductive proppant is injected into the well; therein, the volume of the fracturing fluid containing electrically conductive proppant depends on the predefined investigation depth of electromagnetic logging tool and the predicted height and width of the hydraulic fracture in its near wellbore zone in such a way that the length of the near wellbore zone of the hydraulic fracture filled with electrically conductive proppant is smaller than the investigation depth of electromagnetic logging tool. Thereafter, fracturing fluid flowback and fracture clean-up are performed. Then, electromagnetic logging is performed within the predefined hydraulic fracturing zone to record measured responses from the hydraulic fracture near wellbore zone containing electrically conductive proppant, and the parameters of the hydraulic fracture near wellbore zone are determined.

### BRIEF DESCRIPTION OF THE DRAWINGS

Further, the embodiments of the claimed disclosure are described in detail with the help of the following drawings.

FIG. 1 shows a schematic illustration of disclosure implementation.

FIG. 2 shows logging in a vertically cased well.

FIGS. 3a), b), and c) show responses from electrically conductive fractures in a vertically cased well for various transmitter—receiver distances H_{TR}: a) 0.5 m; b) 1 m; and c) 2 m.

FIG. 4 shows logging in a horizontally cased well.

FIGS. 5 a), b), and c) shows responses from electrically conductive fractures in a horizontally cased well for various transmitter—receiver distances H_{TR}: a) 0.5 m, 6) 1 m, B) 2 m.

### DETAILED DESCRIPTION OF THE EMBODIMENTS

Formation hydraulic fracturing is understood as the stimulation of hydrocarbon production from a well by creating a high-permeability zone filled with proppant. The efficiency of hydraulic fracturing, ultimately determined by production growth, depends on the dimensions of a fracture filled with proppant (the so-called reservoir contact area).

Currently, there is no commercially available method for determining the location of the fracture filled with proppant. Even the most widely used microseismic monitoring employed to determine the geometry and dimensions of the hydraulic fracture does not give an indication of the proppant position inside the fracture. Hence, the method for determining the position of proppant will be increasingly in demand for estimating hydraulic fracturing efficiency and, thus, for optimising both the injection schedule and well completion strategy.

The idea of imparting magnetic or electrically conductive properties to proppant in order to determine its position throughout the entire fracture by means of electromagnetic methods with a high investigation depth is broadly represented in the above analysis of the prior art. The main difficulties related to the determination of the geometry of the entire fracture are: the necessity for applying the expensive electromagnetic method with a large investigation depth, which may be complicated by the availability of an additional (monitoring) well; and the high cost of producing large volumes of electrically conductive proppant required to fill the fracture entirely.

The present disclosure also uses electrically conductive proppant and electromagnetic measurements. Therewith, in contrast to the prior art, the present disclosure evaluates the effectiveness of stimulation in the near wellbore zone by determining the width of a fracture filled with proppant to detect undesirable overflush, which may have an adverse effect on the well production. In addition, the use of induction logging with three-axis coils can yield very valuable information about the azimuth and dip angle of the fracture near the well.

Generally, the efficiency of stimulation in the near wellbore zone is qualitatively estimated by injecting radioactive isotopes (tracers) with subsequent radioactive logging. Therewith, the measured intensity of radioactive radiation is proportional to the fracture width in the near wellbore zone. The present disclosure uses a similar approach, which, however, yields a quantitative rather than a qualitative result. Besides, it does not use of hazardous radioactive materials.

The present disclosure does not address the production of electrically conductive proppants. A mixture of proppant with electrically conductive strips protected by patent U.S. Pat. No. 6,725,930 or proppant particles coated with metal can be considered as good examples of such materials and be used in the present disclosure.

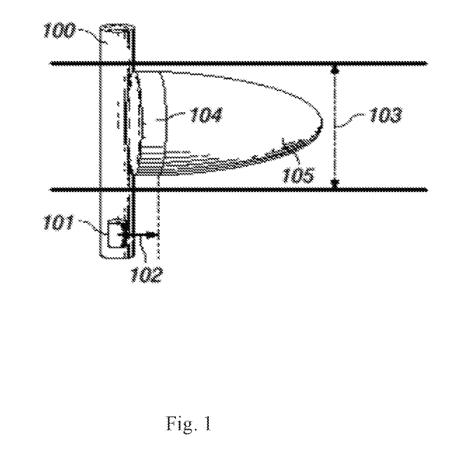

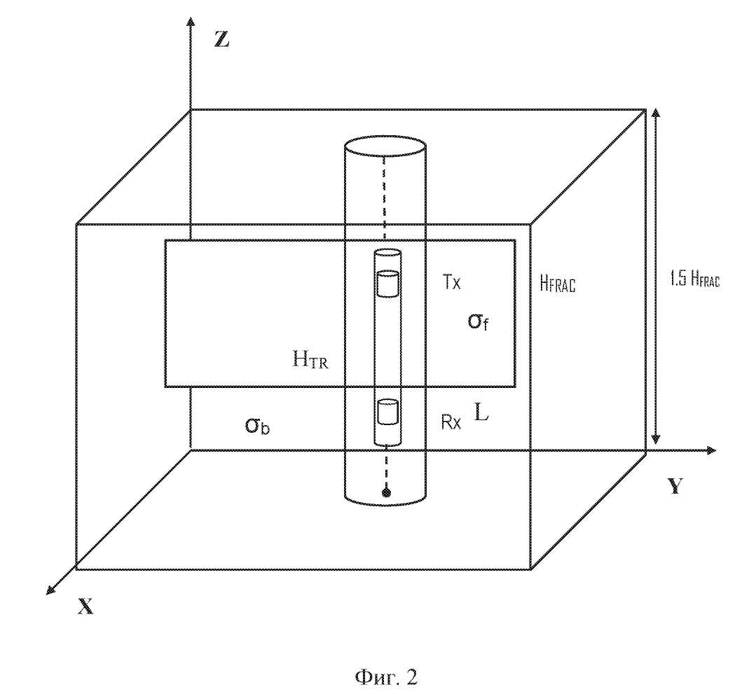

FIG. 1 shows a schematic illustration of the claimed method. The present disclosure relates to a method for determining the parameters of the hydraulic fracture (105) near wellbore zone (104) (at distances up to 10 m from the wellbore (100)), such as its width, length, dip angle, and azimuth. The fracture near wellbore zone is filled with a small volume (˜5% of the full volume of injected proppant) of electrically conductive proppant with conductivity>10 S/m, which is injected during the last fracturing stage. The parameters of the fracture near wellbore zone are determined by means of electromagnetic measurements performed by an induction logging tool (101) in a well before and after hydraulic fracturing within the predefined hydraulic fracturing zone (103). The induction logging tool comprises a transmitter and several receivers composed of combined three-axis antennas that are magnetic dipoles and operate at frequencies from 0 to 1 kHz. The distance between the transmitter and the group of receivers can be from 3 to 100 m. An embodiment of the induction logging tool is presented in patent U.S. Pat. No. 6,690,170 B2.

According to the claimed disclosure, the logging tool (102)—for example, the above tool—is run into the treatment well (100), e.g. a cased well with a cemented casing and perforation clusters within the predefined hydraulic fracturing zone (103) or an open hole well, after which electromagnetic logging is performed before formation hydraulic fracturing within the predefined zone of the pay formation to record response from the medium without a fracture. Then, to calculate the proppant and fracturing fluid volumes, both theoretically predicted hydraulic fracture dimensions and the volumes of fluid and proppant required for injection are determined using the following procedures. For conventional formations, planar hydraulic fracture models are used, such as: PKN, KGD and P3D (J. Adachi, E. Siebrits, A. Peirce, and J. Desroches, “Computer simulation of hydraulic fractures,” Int. J. of Rock Mech. & Mining Sci., no. 44, pp. 739-357, 2007). The modelling of a complicated network of hydraulic fractures formed during hydraulic fracturing in gas sandstones and shale deposits can be implemented using the UFM model (X. Weng, O. Kresse, C. Cohen, R. Wu, and H. Gu, “Modeling of Hydraulic Fracture Network Propagation in a Naturally Fractured Formation,” SPE 140253, 2011).

After this, hydraulic fracturing operations are performed, such as the well injection of the fracturing fluid not containing proppant (pad), using both the predicted hydraulic fracture dimensions and the volumes of fluid and proppant required for injection to create the fracture (105) in the formation. Then, the fracturing fluid containing electrically non-conductive proppant is injected into the well, using both the predicted hydraulic fracture dimensions and the volumes of fluid and proppant required for injection.

Then, the first stage is performed, during which the fracturing fluid containing electrically conductive proppant is injected in the well, while the volume of the fracturing fluid containing electrically conductive proppant depends on the predefined investigation depth (102) of electromagnetic logging tool and the predicted height and width of hydraulic fracture in its near wellbore zone in such a way that the length of the hydraulic fracture near wellbore zone filled with electrically conductive proppant is smaller than the investigation depth of electromagnetic logging tool. At the same time, the electrical conductivity of electrically conductive proppant is higher than the electrical conductivity of either electrically non-conductive proppant or the electrical conductivity of the host medium.

After the injection of the fracturing fluid containing electrically conductive proppant into the well, fracturing fluid flowback and fracture clean-up are performed, for example, by opening a valve at the wellhead.

After the clean-up of the well, electromagnetic logging is performed within the predefined hydraulic fracturing zone to record measured responses from the hydraulic fracture near wellbore zone containing electrically conductive proppant.

In one of the embodiments, a response is corrected for the casing, using a smaller antenna located near the main antennas.

Since the tool will be used in both vertical and deviated wells, the determination of the structural parameters uses a tensor transfer impedance (Vij/Iij) obtained as the ratio between a complex-valued voltage in the receiver and a complex-valued current in the source for combinations of three-axis antennas.

For small transmitter—receiver distances, the measured tensor response will be inverted to obtain the values of Rh, Ry, dip angle, and azimuth of layers in the host medium. Large transmitter—receiver distances are used to determine the fracture width, dip angle, azimuth, and length. Also, any other processes are used, depending on the properties of the host medium, casing, and fracture.

To determine the parameters of a fracture filled with proppant in the near wellbore zone, the results of the inversion of the measured responses from the hydraulic fracture near wellbore zone containing electrically conductive proppant are compared with the results of the inversion of the measured responses from the medium without a fracture before hydraulic fracturing.

Therewith, the inversion of the measured responses is performed by comparing the measured responses with the results of a forward problem solution, while the medium model within the predefined hydraulic fracturing zone for which differences between the results of the forward problem solution and the measured responses do not exceed the predefined threshold value is taken as the inversion result.

The forward problem solution is defined as the numerical modelling of an electromagnetic logging response for the medium model within the predefined hydraulic fracturing zone using the finite element method. As an embodiment of the disclosure, the forward solution is defined using the numerical modelling of an electromagnetic field in a medium with thin conductive objects by the vector finite element method on a tetrahedral grid on the full hierarchical basis of the full second order using a modified variational formulation.

The above numerical modelling is performed using one of the procedures disclosed, for example, in Garry Rodrigue, Daniel White. “A Vector Finite Element Time-Domain Method for Solving Maxwell's Equations on Unstructured Hexahedral Grids” SIAM J. Sci. Comput. 2001. v. 35, p. 315-341; O. V. Nechaev, E. P. Shurina. “Multigrid Algorithm of Solving a Three-Dimensional Helmholtz Equation by the Vector Finite Element Method”//Mathematical Modelling. 2005 V. 17, No. 6. pp. 92-102; Webb J. P. “Edge Elements and What They Can Do for You”/IEEE Transaction on Magnetic, 1993, No. 2, p. 1460-1465; J. C. Nedelec. Mixed Finite Elements in R3.—In: Numer. Math., No. 3, 1980, p. 315-341; Hiptmair R. “Multigrid Methods for Maxwell's Equations”//SIAM J. Nymer. Anal., 1998, No. 1, p. 204-225; Lars S. Andersen, John L. “Hierarchical Tangential Vector Finite Elements for Tetrahedra”.—IEEE Microwave and Guide Wave Letters, 1998, No. 3. p. 8; O. Nechaev, E. Shurina, M. Botchev. “Multilevel Iterative Solvers for the Edge Finite Element Solution of the 3D Maxwell Equation”, Computers and Mathematics with Applications. No. 10-2008, p. 2346-2362; M. I. Epov, E. P. Shurina, D. A. Arkhipov. “Parallel Finite Element Computational Schemes in Problems of Geoelectrics,” Computational Technologies.—2013. T.18.—Nº 2.—pp. 94-112.

Examples of numerical modelling given below illustrate the possibility of determining the dimensions of a fracture filled with proppant using this procedure. The tool response was modelled for logging both in vertical and horizontal cased wells having the following input parameters:

Conductivity of fracture σ_{f}: 1,000 S/m.

Conductivity of host medium σ_{b}: 0.2 S/m.

Half-length of fracture L: 2, 5, 95 m.

Height of fracture H_{frac}: 50 m.

Width of fracture W_{frac}: 2.5, 5 mm

Generator—receiver distance: H_{TR}: 0.5, 1, 2 m

Current in the transmitting coil: 20 A

Signal frequency 100 Hz

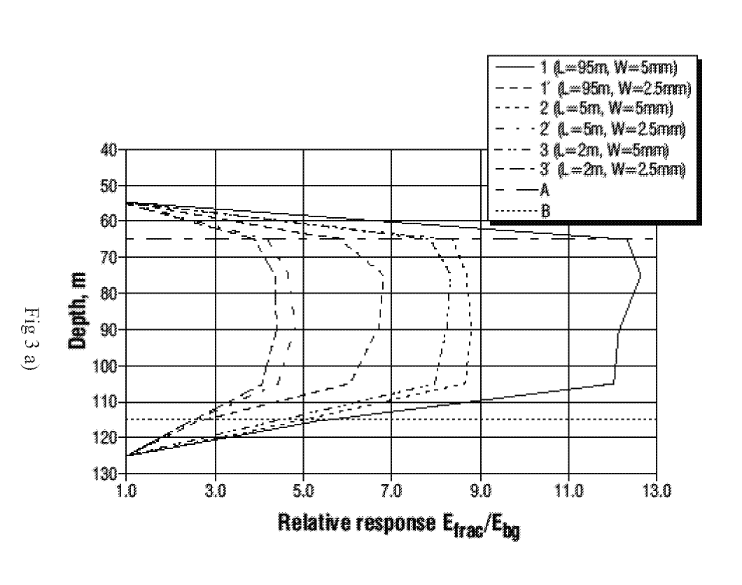

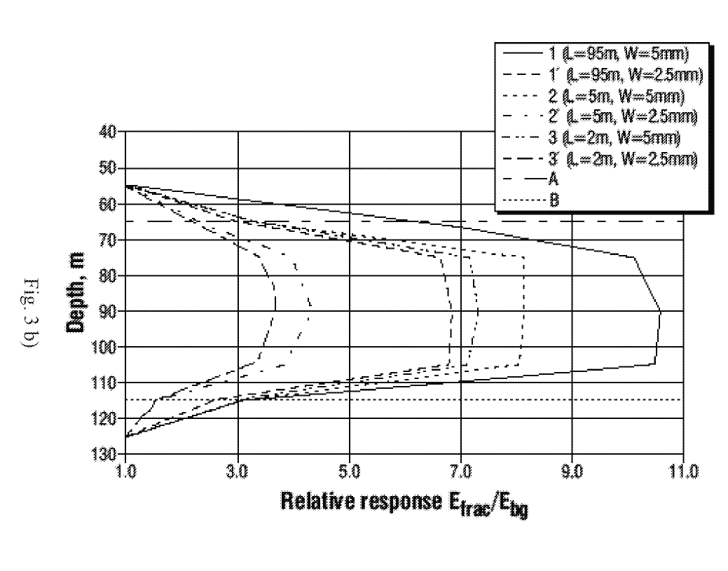

A vertical cased well, a logging tool, and a vertical fracture adjacent to the wellbore are shown in FIG. 2, which represents the analysis of the response sensitivity in the electromagnetic device in relation to the length and width of an electrically conductive fracture in the vertical cased well.

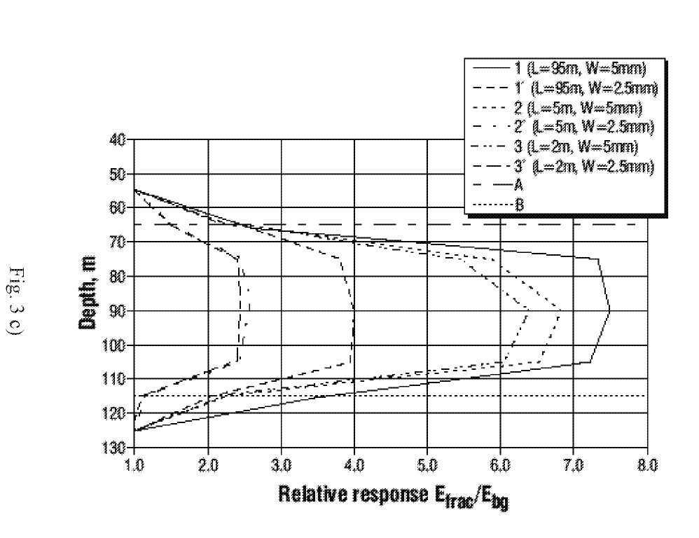

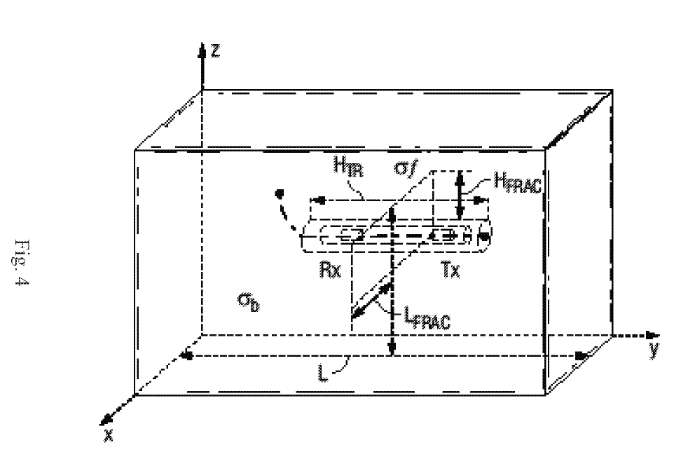

The diagrams in FIG. 3a)-FIG. 3c) show relative responses E_{frac}/E_{bg} from the vertical fracture measured in a receiver coil along the logged section in the vertical cased well, wherein E_{frac} and E_{bg} are the values of electromotive force (EMF) calculated for the models with and without fracture, respectively. The diagrams are plotted in the form of log curves, wherein the vertical axis corresponds to the depth, and the horizontal axis—to the relative response value. Two horizontal lines A and B in the diagrams designate the upper and lower fracture borders. The curves of relative responses from the fractures with half-lengths of 2 and 5 metres illustrate the resolution capability of the method in the near wellbore zone of the fracture, while the fracture with the half-length of 95 metres indicates a far-field response.

It can be seen from the diagrams that both the half-length and width of the fracture can be easily discernible for small transmitter—receiver distances H_{TR} of 0.5 and 1 m shown in FIGS. 3a) and b) even in the near field. For the transmitter—receiver distance H_{TR} of 2 m, a relative response becomes less sensitive to the half-length for a thin fracture but more sensitive to the fracture width as shown in FIG. 3c).

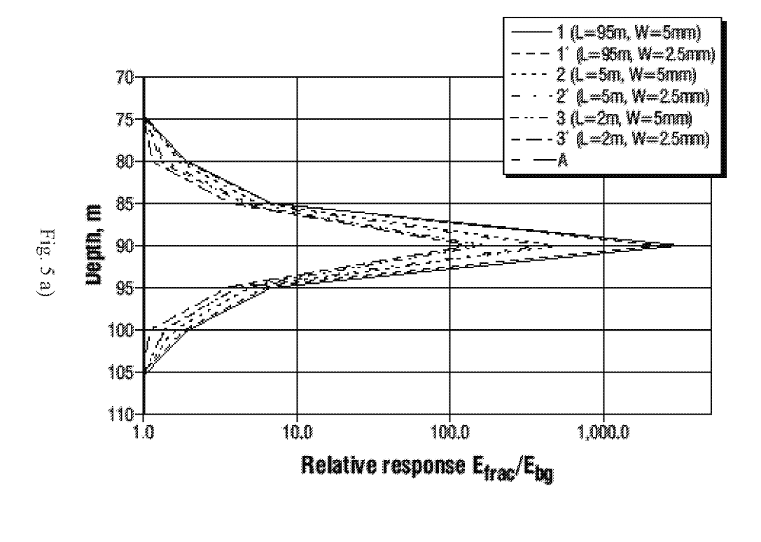

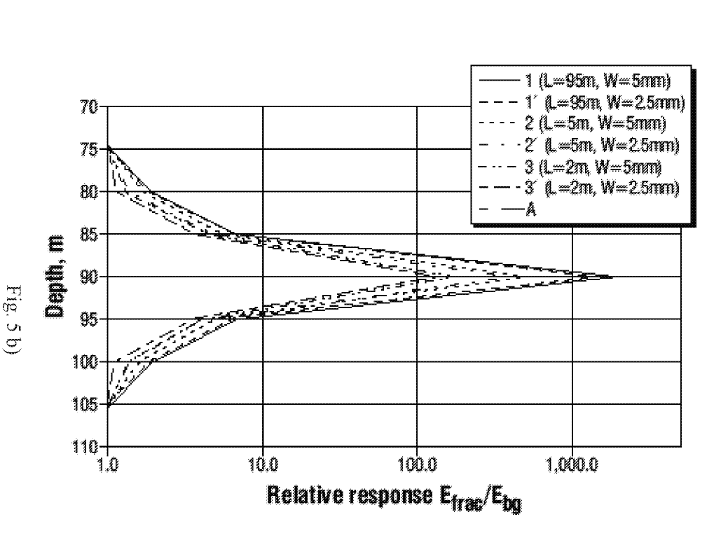

FIG. 4 shows a horizontal cased well, a logging tool, and a vertical fracture perpendicular to the wellbore.

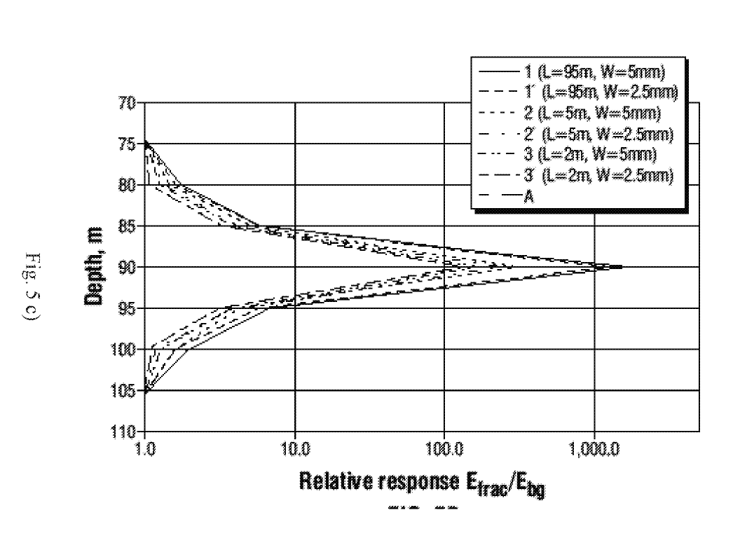

Similarly to the results from the previous example, FIG. 5a)-5c) show relative responses E_{frac}/E_{bg} plotted for a horizontal well, while line A illustrates the fracture location.

As can be seen from the presented results, the response from a fracture perpendicular to the wellbore is two orders of magnitude higher than the response occurring when a fracture is adjacent to the wellbore, due to the effect of electromagnetic coupling with the transmitting coil. Also, it can be observed that the response is more sensitive to the fracture half-length than to its width.

The claimed disclosure provides the following advantages:

injection of only a small volume of electrically conductive proppant allows to make well treatment cheaper;

investigation of the near wellbore zone of the fracture allows to use inexpensive small-depth methods which, furthermore, do not require the availability of an additional well;

investigation of the near wellbore zone of the fracture do not require a large contrast in electrical conductivity between a proppant pack and the host formation, which also reduces costs for the production of electrically conductive proppant; and

finally, information on the width of the fracture, its azimuth and dip angle in the near wellbore zone may be determining when investigating its productivity and, therefore, may be in high demand.

The above embodiments should not be treated as limiting the scope of the patent claims of the disclosure. It is apparent to any specialist in the area that there is a possibility to make a number of changes in the above procedure without departing from the principles of the disclosure stated in the claims.

1. A method for determining the parameters of the hydraulic fracture near wellbore zone, which comprises the following:
forming either a cased and cemented borehole with perforation clusters within the predefined hydraulic fracturing zone or an open hole well;
electromagnetic logging prior to formation hydraulic fracturing within the predefined zone of the pay formation to record a response from the medium without a fracture;
determination of both theoretically predicted hydraulic fracture dimensions and the volumes of fluid and proppant required for injection;
performing the stage, during which the fracturing fluid not containing proppant is injected into the well, by using both the predicted hydraulic fracture dimensions and the volumes of fluid and proppant required for injection to create a fracture in the formation;
performing the stage, during which the fracturing fluid containing electrically non-conductive proppant is injected into the well, by using both the predicted hydraulic fracture dimensions and the volumes of fluid and proppant indispensable for injection to create a fracture in the formation;
performing the stage, during which the fracturing fluid containing electrically conductive proppant is injected into the well; therein, the volume of the fracturing fluid containing electrically conductive proppant depends on the predefined investigation depth of electromagnetic logging and the predicted height and width of the hydraulic fracture in its near wellbore zone in such a way that the length of the hydraulic fracture near wellbore zone filled with electrically conductive proppant is smaller than the investigation depth of electromagnetic logging;
provision of fracturing fluid flowback and fracture clean-up;
performance of electromagnetic logging within the predefined hydraulic fracturing zone to record measured responses from the hydraulic fracture near wellbore zone containing electrically conductive proppant; and
determination of the parameters of the hydraulic fracture near wellbore zone.

2. The method of claim 1, wherein the parameters of the hydraulic fracture near wellbore zone comprise the width, height, dip angle, and azimuth of the fracture and the length of the fracture near wellbore zone.

3. The method of claim 1, wherein the parameters of the hydraulic near wellbore zone are determined by comparing the results of the inversion of the measured responses from hydraulic fracture near wellbore zone containing electrically conductive proppant with the results of the inversion of the measured responses from the medium without a fracture prior to formation hydraulic fracturing.

4. The method of claim 3, wherein the inversion of the measured responses is performed by comparing the measured responses with the results of the forward problem solution, while the medium model within the predefined hydraulic fracturing zone for which differences between the results of the forward problem solution and the measured responses do not exceed the predefined threshold value is taken as the inversion result.

5. The method of claim 4, wherein the forward solution is defined as the numerical modelling of an electromagnetic logging response for the medium model within the predefined hydraulic fracturing zone using the finite element method.

6. The method of claim 1, wherein the electrical conductivity of electrically conductive proppant is higher than the electrical conductivity of either electrically non-conductive proppant or the electrical conductivity of the host medium.

7. The method of claim 1, wherein electromagnetic logging is performed by means of an induction logging tool.

8. The method of claim 7, wherein the induction logging tool comprises a transmitter and a group of receivers composed of one-axis, deviated, or combined three-axis antennas that are magnetic dipoles and operate at frequencies from 0 to 1 kHz.

9. The method of claim 8, wherein the distance between the transmitter and the group of receivers is from 3 to 100 m.
